(19) United States
(12) Patent Application Publication
(10) Pub. No.: US 2005/0038588 A1
(43) Pub. Date: Feb. 17, 2005

(54) Vehicle driving force control method

(76) Inventor: Deepak Shukla, Canton, MI (US)

Correspondence Address: Douglas A. Mullen;Dickinson Wright PLLC, Suite 800, 1901 L. Street N.W., Washington, DC, 20036, US

(21) Appl. No.: 10/641,411

(22) Filed: Aug. 14, 2003

(51) Int. Cl. G06F 19/00

(52) U.S. Cl. 701/70; 701/80

(57) ABSTRACT

A method of controlling the wheel speed of a vehicle wheel supported by a surface to achieve a desired vehicle acceleration, desired yaw rate or a desired vehicle velocity. The method receives sensor readings indicative of a vehicle state and operator input. From the received sensor readings a current wheel speed and a desired wheel speed are determined. A torque is applied to the wheel to correct for any wheel speed error, the difference between the desired wheel speed and the current wheel speed. To determine the amount of torque that may be applied to the vehicle wheel while preventing the wheel from slipping, a friction coefficient between the wheel and the surface may be determined.

### BACKGROUND OF THE INVENTION

The present invention generally relates to a method for achieving a desired acceleration or a desired yaw rate and more specifically to a method of controlling wheel speed to achieve a desired vehicle acceleration or a desired vehicle yaw rate.

Many modern vehicles include systems to stabilize the vehicle during evasive maneuvers or during operation on less than ideal conditions. In general, to improve the vehicle dynamic response by correcting the vehicle's yaw rate or acceleration, these systems generally estimate the tractive force required between the wheel and road surface and then calculate and apply a torque to a target wheel to generate that tractive force. In calculating the torque to be applied, these systems also calculate the maximum wheel torque that can be sustained by the interaction between the tire and the road so that any torque applied to the wheel is not greater than what can be sustained, thereby preventing the wheel from slipping. One problem with calculating the torque to be applied to a wheel is that determining the current torque on the wheel from the road is difficult, complex, and computationally intensive. Currently available torque sensors do not provide an economical means for measuring the amount of torque applied to the wheel or the torque magnitude (traction force) supportable by the interaction between the tire and the road without slip. An accurate estimation or determination of torque to be applied to the wheel is needed to improve the operational dynamics of the vehicle, such as to correct the vehicle's yaw rate or acceleration while preventing the wheel from slipping.

### SUMMARY OF THE INVENTION

The present invention is directed to a method for achieving a desired acceleration, a desired yaw rate, or a desired vehicle velocity. More specifically, the present invention is directed to a method of controlling wheel speed to achieve a desired vehicle acceleration, a desired vehicle yaw rate, or a desired vehicle velocity.

The method of controlling the wheel speed of a vehicle wheel supported by a surface generally includes the steps of receiving a first and second sensor reading indicative of a vehicle state, determining a current wheel speed from the first sensor reading, determining a desired wheel speed from the second sensor reading, determining a wheel speed error based on the difference between the desired wheel speed and the current wheel speed, and determining a torque to be applied to the vehicle wheel from the wheel speed error. To determine the amount of torque that may be applied to the vehicle wheel while preventing a wheel from slipping, the method may include the steps of determining a friction coefficient between the wheel and the surface, determining a current wheel torque using the desired wheel speed, sensor readings and friction coefficient, determining a maximum torque that may be applied without slip of the vehicle wheel, and ensuring that the sum of the torque to be applied and the current torque is less than or approximately equal to the maximum torque.

The vehicle velocity is determined from the current wheel speed. Depending on the type of vehicle control desired, the vehicle may determine a desired wheel speed based on a desired vehicle velocity, desired yaw rate, desired vehicle acceleration or any combination of the above. In determining the desired vehicle velocity, the method may use the vehicle's current acceleration. In determining the wheel speed error, the method may further include the step of determining a yaw rate error.

In an alternative embodiment, the method of controlling the wheel speed of a vehicle wheel supported by a surface includes, receiving a sensor reading indicative of a vehicle travel state, receiving a sensor reading indicative of operator input, determining a desired yaw rate from the sensor readings indicative of vehicle travel state and the sensor readings indicative of operator input, determining a current wheel speed, determining a desired wheel speed using the desired yaw rate, calculating a wheel speed error based on the difference between the desired wheel speed and the current wheel speed, and determining an applied torque to be applied to the vehicle wheel from the wheel speed error. The method may include the step of determining the desired velocity for the left and right wheels of the vehicle. To prevent the vehicle control system from constantly correcting or overcorrecting, the method may include the step of mapping a hysteresis characteristic and mapping a dead band characteristic.

In yet another alternative embodiment, the method of controlling the wheel speed of a vehicle wheel supported by a surface may include the steps of receiving sensor readings indicative of a vehicle travel state, receiving sensor readings indicative of operator input, determining a desired acceleration from the sensor readings indicative of a vehicle travel state and the sensor readings indicative of operator input, determining a current wheel speed of the vehicle wheel, determining a desired wheel speed of the vehicle wheel from the desired acceleration, calculating a wheel speed error, the wheel speed error being the difference between the desired wheel speed and the current wheel speed, and determining an applied torque to be applied to the vehicle wheel from the wheel speed error.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a flow chart outlining the method of the system including initialization of the variables;

FIG. 2 is a flow chart outlining the repeated method of the system;

FIG. 3 is a schematic diagram of a vehicle including a vehicle driving force control system;

FIG. 4 is a representative relation between the friction coefficient and longitudinal slip ratio;

FIG. 5 is a hysteresis graph of the friction coefficient gradient;

FIG. 6 is a dead band characteristic graph;

FIG. 7 is a flow chart outlining the friction coefficient calculation including initialization of the Fourier series; and

FIG. 8 is a flow chart outlining the friction coefficient calculation cycled method of the system.

### DETAILED DESCRIPTION OF THE PREFERRED EMBODIMENT

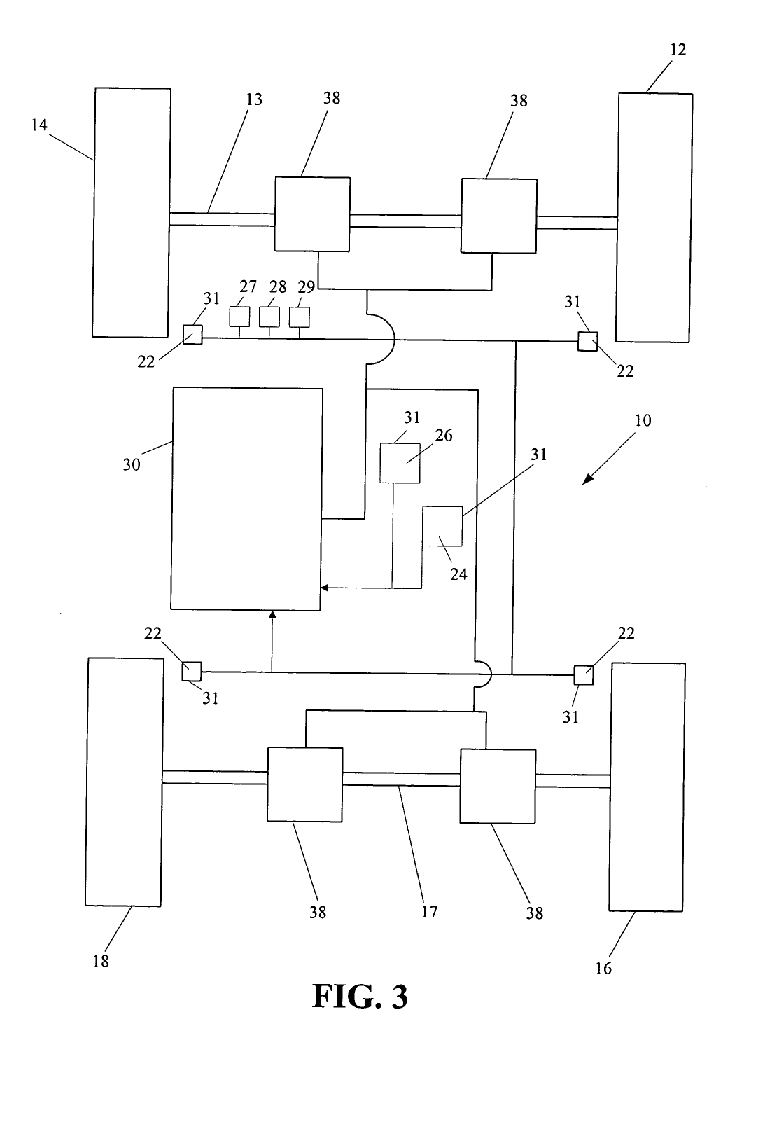

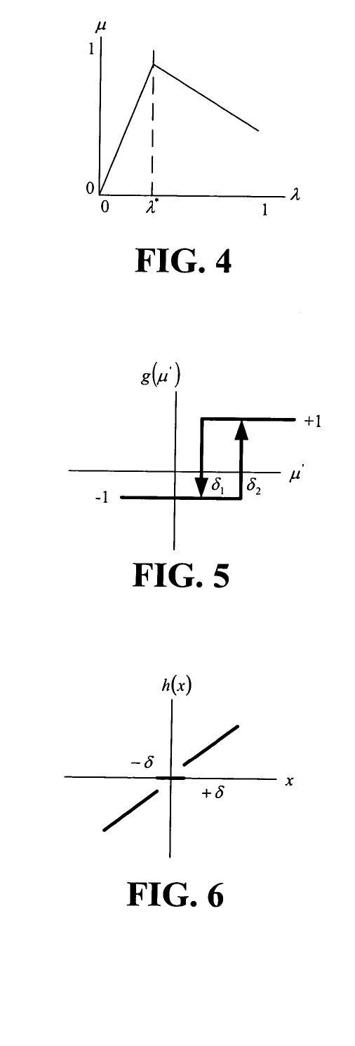

As is shown in FIG. 3, the present invention is generally directed to a vehicle driving force control system 20 and method for achieving a desired yaw rate and/or a desired acceleration quickly, accurately, and efficiently. The system is described and illustrated herein as being incorporated into a vehicle driving force control system. Notwithstanding this context, it should be readily apparent that the system may be used in other contexts for achieving control over the motion of an object. As used in vehicles, the system 20 may readily use existing vehicle sensors 31, such as those commonly associated with anti-lock brake systems, traction control systems, or existing vehicle stability control systems, as indicators of a vehicle travel state. The sensor signals may be communicated to a system processor 30 or any other suitable control unit known in the art, to determine an estimated vehicle velocity. The processor 30 may also determine a desired vehicle yaw rate and a desired vehicle longitudinal acceleration. From the desired yaw rate and/or the desired acceleration, the processor 30 may determine the desired velocity for each wheel. With the desired velocity of each wheel known, the processor 30 may calculate a friction coefficient between the driven wheel and the road surface. The processor 30 may then determine if torque should be applied to the wheel or if the wheel speed is close enough to the desired wheel speed so that torque does not need to be applied. The processor 30 then adjusts the wheel speed of each wheel via application of torque to improve or correct the yaw rate and/or acceleration.

For ease of explanation a vehicle 10 is shown in FIG. 3 to include a front right wheel 12, a front left wheel 14, a rear right wheel 16, and a rear left wheel 18. The vehicle 10 also includes a vehicle driving force control system 20 which generally includes the processor 30, the vehicle sensors 31 and a torque application mechanism 38 such as electric motors for adjusting the torque on a given wheel. The processor 30 may be a conventional processor having various modules communicating with the vehicle sensors 31 and configured to calculate vehicle states such as the vehicle speed, desired yaw rate, desired acceleration, desired vehicle velocity, desired wheel speed for each wheel, and the friction coefficient between a specified wheel and the supporting surface.

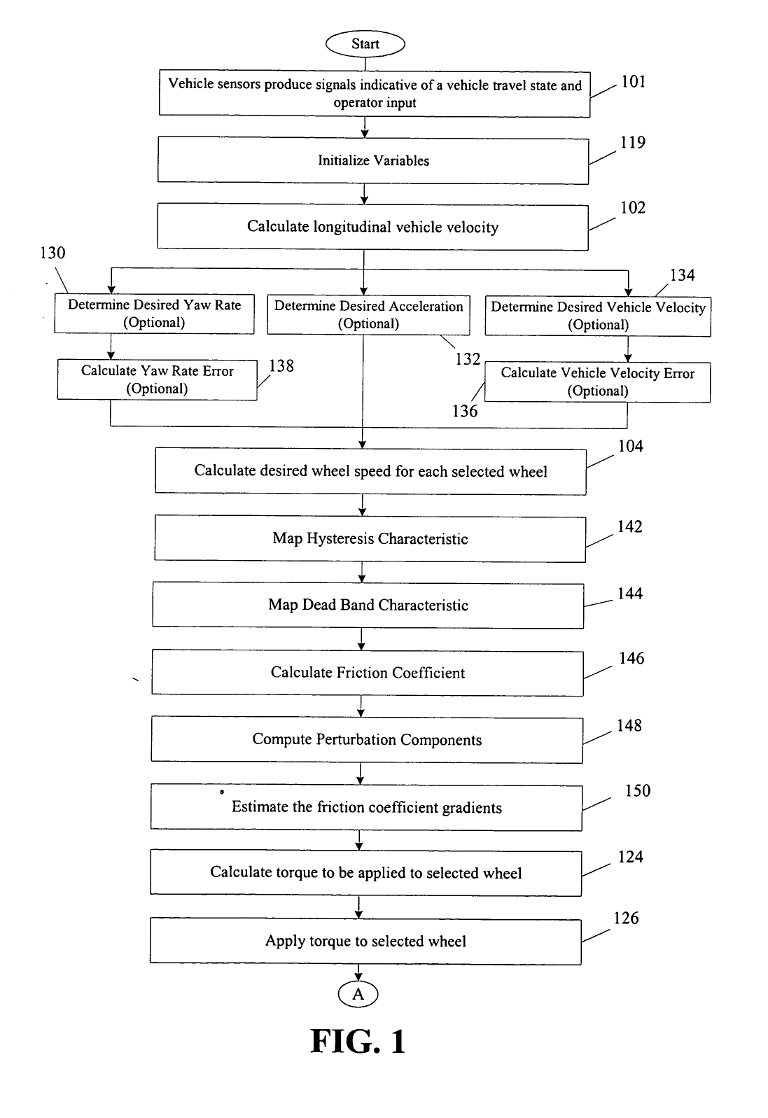

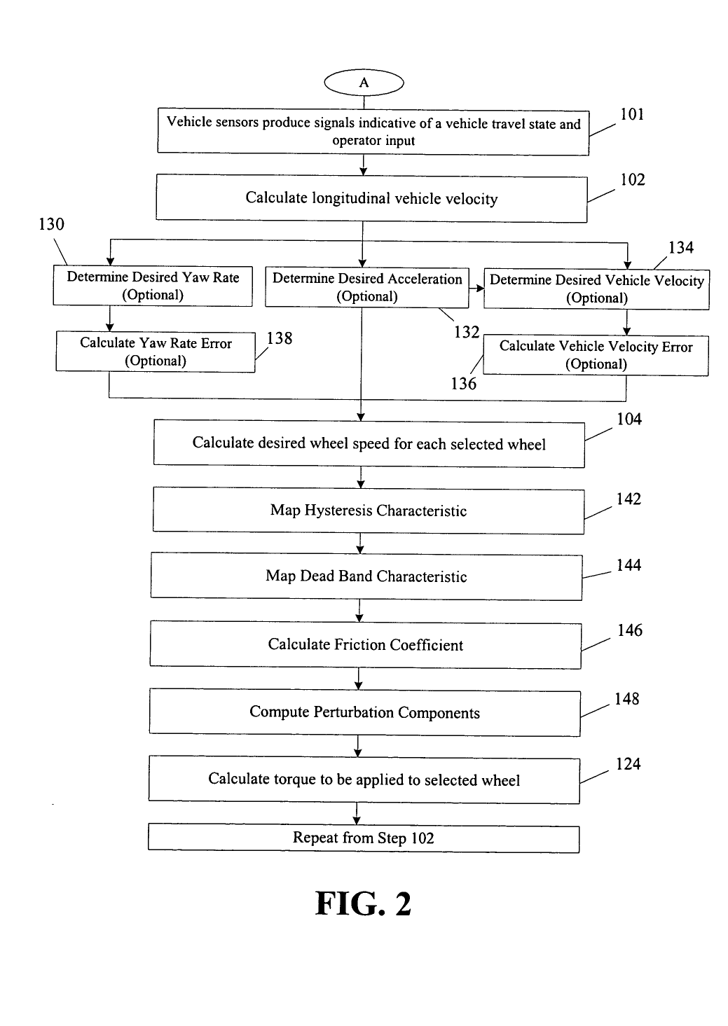

The system and method will now be described in greater detail with reference to the vehicle schematic in FIG. 3, as well as the flow charts illustrated in FIGS. 1 and 2. During the initial cycle, some variables of the equations will need to be initialized, because the system learns during each cycle. The initial values may be set to any value but it is generally preferable to set these values close to the best estimate of true values so that the system may quickly and accurately adjust the acceleration or yaw rate of the vehicle. FIG. 1 shows the preferred steps of the initialization cycle performed by the processor 30, beginning with the receipt of signals indicative of a vehicle travel (Step 101) through the application of torque to a selected wheel (Step 126). FIG. 2 illustrates representative processor steps performed during the repeated or cycled portion of the system and method and generally includes the same steps shown in FIG. 1 except for the initialization of the variables (Step 1119). The initialization (Step 119) is not included in the cycled method, because the initialized variables are generally adjusted to allow the system to learn. As described in greater detail below, the method is generally repeated or cycled at least 50 to 200 times a sec.

The following description of the system 20 refers to the processor 30 performing the calculations and receiving the signals. Those skilled in the art will appreciate that the description of the processor is provided in a large part for ease of explanation and that the system and the method may be implemented through the use of any number of processing techniques, including hardware or software implemented structures generally known in the art which may or may not include single processor, separate processors, or modules. The processor 30 generally receives signals from the vehicle sensors 31 (Step 101, FIGS. 1 and 2) that are indicative of the vehicle's current travel state and the operator's input, which are indicative of the vehicle's desired operating characteristics. The signals that are indicative of the vehicle's travel state generally include, in the illustrated embodiment, a wheel speed signal, an acceleration signal, vehicle velocity signal and a vehicle yaw rate signal. The wheel speed signal is generally provided by a wheel speed sensor 22, which is known in the art and commonly used in anti-lock brake systems, traction control systems, and vehicle stability control systems. The acceleration signal is generally provided by an accelerometer 24 and the yaw rate signal is provided by a yaw rate sensor 26. Yaw rate sensors and accelerometers are also generally well known in the art and are commonly used in modern vehicle stability control systems. Other signals such as a GPS signal may be used in addition or in place of the above signals to provide information about the current vehicle travel state.

Accelerometers 24 are commonly used in vehicle stability control systems to measure the rate of changes in linear velocity. Two accelerometers may be used, one for measuring longitudinal acceleration, the other for measuring lateral acceleration. The longitudinal acceleration signal provides information on velocity changes in the longitudinal direction, such as during acceleration or braking. In the illustrated embodiment, the accelerometer 24 provides a longitudinal acceleration signal to the processor 30, but the lateral signal may be helpful in determining road bank or slope, lateral velocity, and lateral acceleration if needed. The yaw rate sensor 26 is typically placed near the vehicle's center of gravity and measures rotational movement of the vehicle about its vertical axis.

In the illustrated embodiment the signals that are generally indicative of the operator's input or operator's interaction with the vehicle generally include a throttle position signal, a brake position signal, and a steering wheel angle signal. The throttle position signal is generally provided by a throttle position sensor 27 which may measure the position of a throttle body or a throttle pedal. The brake pedal position signal is generally provided to the processor 30 by a brake position sensor 28, which measures the amount that a brake pedal is offset from a rest position or the amount of braking force being applied. The steering wheel angle signal is provided by a steering wheel angle sensor 29 which in the illustrated embodiment is related to the amount that the steering wheel is offset from a rest position. Alternatively, the steering wheel angle sensor 29 may measure the amount that a vehicle's wheels are offset from the longitudinal axis of the vehicle.

The longitudinal velocity of the vehicle may be calculated in any suitable manner known in the art. The most common method of calculating the longitudinal velocity is measuring the number of times a wheel rotates in a given time period, which gives the wheel angular velocity. The longitudinal velocity of the vehicle may be calculated by multiplying the radius of an undriven vehicle wheel by the wheel angular velocity. The wheel radius and other vehicle parameters, such as inertia of the wheel and connected drive train, and the distance between the wheels, are known and may be stored in processor memory. In less than ideal conditions where a wheel may be slipping or where all wheels are driven, which may give an inaccurate vehicle velocity calculation, it may be desirable to calculate the vehicle longitudinal velocity by any other known technique, such as a Luenberger model. Examples of additional techniques include using the average of the undriven wheel speed or GPS informational system. Longitudinal acceleration may also be calculated for vehicles without accelerometers by measuring the change in a vehicle's longitudinal velocity over a specified time period.

The system and method may adjust a vehicle's yaw rate, assist in changing the acceleration of a vehicle, and/or assist in changing the velocity of the vehicle. More specifically, the processor 30 receives signals indicative of a vehicle state, including a vehicle travel state and operator input (Step 101), and determines the desired yaw rate (Step 130), desired acceleration (Step 132), and/or desired vehicle velocity (Step 134). Each of the steps (130, 132, and 134) associated with the processor 30 determining a desired vehicle operating state is optional in that the processor may calculate one of, a combination of, or all of the desired yaw rate (Step 130), desired acceleration (Step 132) or desired vehicle velocity (Step 134). From the desired yaw rates, accelerations, or vehicle velocities, the processor 30 may then calculate the desired wheel speeds (Step 104) for each wheel and adjust each wheel accordingly (Step 126). Therefore, the processor 30 may adjust the wheel speed of a particular wheel to assist the vehicle in reaching desired vehicle operating states, such as adjusting the wheel speed to approach the desired vehicle yaw rate, adjusting the wheel speed for a combination of desired vehicle operating states, such as adjusting the wheel speed to assist the vehicle in reaching both the desired vehicle yaw rate and desired vehicle acceleration, or adjusting the wheel speed for all desired vehicle operating states. In general, the desired wheel speeds are determined by taking into account the operator's input, the vehicle's current operating characteristics, and the maximum torque that may be applied to each wheel without the wheel slipping.

With the calculated vehicle velocity and the received operator inputs, the processor 30 may calculate the yaw rate error (Step 138) and the vehicle velocity error (Step 136). As above, the calculation of the errors is optional depending on whether the processor 30 calculates the corresponding desired vehicle operating condition.

The desired yaw rate may be determined (Step 130) through the well known technique of yaw rate mapping. A yaw rate map is generally created during real world testing by measuring the yaw rate (r) for various combinations of vehicle velocities and steering wheel angles on a high friction surface such as dry asphalt. It is fairly standard practice that each vehicle manufactured is tested to create this yaw rate map. In the illustrated embodiment, the yaw rate map is stored in processor memory so that the processor may look up the desired yaw rate based upon the current vehicle velocity and steering wheel angle. If a yaw rate map is not available, the desired yaw rate may be functionally described as:
r_{d}=f_{yaw}_{_{—}}ₘₐₚ(vₓ,vₛₜ) (1)
where r_{d} is the desired yaw rate, vₓ is the vehicle velocity, vₛₜ, is the steering wheel angle, and f_{yaw}_{_{—}}ₘₐₚ is a function created unique to a particular vehicle model that may be created to relate vehicle velocity to the steering wheel angle and yaw rate. This function is generally determined by testing the vehicle on a high friction surface. The function may also be used to create a yaw map, which is then stored in processor memory. This desired vehicle yaw rate may then be compared to the actual yaw rate, as described below.

The desired acceleration rate may be determined by a process analogous to vehicle yaw mapping. By vehicle modeling or vehicle testing on high friction surfaces a function or map unique to each vehicle may be determined. This function takes into account the vehicle velocity as well as the throttle position and brake position. The system 20 may use the determined desired acceleration function by inputting the throttle position, brake position, and vehicle velocity to calculate the desired vehicle acceleration. Of course the results of the function may already be calculated and provided in a look-up table in the processor memory so that the processor 30 looks up in the table the throttle position, brake position, and vehicle velocity to determine the desired vehicle acceleration. The throttle position and brake position are non-linearly mapped to the vehicle longitudinal acceleration, which refers to the acceleration a vehicle should have if there are no external losses such as aerodynamic or viscous losses due a body moving into a fluid medium (air). A proposed desired acceleration may be summarized as:
α_{x,d}=Hₜₕ(s)f(xₜₕ,vₓ)−k_{br}x_{br} sgn(vₓ)−kᵥ|vₓ|−kₐv²ₓ (2)
where α_{x,d} is the desired (steady state) acceleration of the vehicle, xₜₕ is the input from throttle position, H(s) represents a second order transfer function, H(s) f(xₜₕ,vₓ) represents nonlinear dynamic mapping between throttle position, vehicle velocity and engine supported tractive force per unit vehicle mass, x_{br} is the input from brake (position), k_{b}, is the proportionality constant between brake input and no-loss vehicle deceleration, vₓ is the actual or estimated longitudinal velocity of the vehicle, kᵥ is the proportionality constant for viscous losses, and k_{α} is the proportionality constant for aerodynamic losses, the function ‘sgn(x)’ is signum function that represents the sign of a quantity and has output of 1 if its argument (‘x’) is positive, of −1 if the argument is negative and zero if its argument is zero. The non-linear mapping function f (xₜₕ,vₓ) is unique to each vehicle, as well as the transfer function H(s), and may be determined from vehicle test data using straight line acceleration tests on high friction surfaces. The constant k_{br} can be determined from the braking characteristics by using a linear relation between the brake pedal input and the brake torque on the wheel, from which the wheel deceleration force can be transformed to vehicle deceleration. In the illustrated embodiment, the braking effect is not considered for simplicity, but it should be readily obvious to one skilled in the art to account for the braking force. The constant k_{α} can be determined as k_{α}=0.5C_{D}ρA/m where C_{D} is the drag coefficient for the car, ρ is the density of the medium, and A is the frontal area of the car. The drag coefficient C_{D} may be obtained from either the vehicle's manufacturing data sheet or any relevant vehicle test data. In the illustrated embodiment, k_{α} and kᵥ are determined using test data and used to provide a better approximation of the desired vehicle acceleration.

Desired vehicle velocity is generally a function of the desired acceleration and is calculated using the desired vehicle velocity from the previous step plus the desired acceleration multiplied by the sample time. The desired vehicle velocity may be calculated as follows:

$${v}_{s , d} ( {t}^{+} ) = {v}_{x , d} ( {t}^{-} ) + {\int }_{{t}^{-}}^{{t}^{+}} {a}_{x , d} ⅆ t \qquad ( 3 )$$

where v_{x,d}(t⁺) is the current desired vehicle velocity, v_{x,d} (t⁻) is the previous desired vehicle velocity, and α_{x,d} is the desired vehicle acceleration at any instance of time. For the initial cycle, as shown in FIG. 1, the desired vehicle velocity is approximated by using the actual vehicle velocity.

Once the processor calculates the desired yaw rate and desired vehicle velocity, the vehicle velocity error and yaw rate error may be calculated (Steps 136 and 138). More specifically, because the vehicle state vector for the motion of the vehicle consists of a vehicle longitudinal velocity, vehicle lateral velocity, and vehicle yaw rate, the lateral velocity (v_{y}) may be handled indirectly using the steering wheel angle correction by the driver which in turn activates the yaw stability control component to correct the vehicle path, including the vehicle lateral position as desired by the driver. Therefore the vehicle state error for control purposes consists of only two components, the longitudinal velocity error and the yaw rate error. The longitudinal velocity error may be calculated as follows:
eᵥ=v_{x,d}−vₓ (4)
where eᵥ equals the longitudinal velocity error, v_{x,d} equals the desired velocity, and vₓ equals the actual velocity. The yaw rate error may be calculated using the following equation:
e=r_{d}−r (5)
where eᵣ equals the yaw rate error, rd equals the desired yaw rate, and r equals the actual yaw rate. The goal of the vehicle control is to have the absolute value of eᵥ and eᵣ approach zero.

Typical vehicle dynamics control systems directly compute the required torque on the wheels based on yaw rate and based on slip of primary driven wheels. Other prior art systems required determination of the angular velocity of the wheel, which can only be calculated by differentiating the angular velocity of the wheel, thereby amplifying noise in the differential signal, making the signal very noisy, which degrades performance of the system. The present invention instead controls acceleration and yaw-rate by tracking the desired vehicle velocity and desired yaw-rate, calculating the desired wheel velocity, and adjusting the wheel speed by applying controlled torque until the system records a successful tracking (i.e., stops assisting) when the vehicle acceleration and/or yaw-rate error drops below a threshold value. Vehicle velocity tracking system includes resetting of the integrator in Equation 3 to make the desired vehicle velocity equal to the estimated or actual vehicle velocity when the acceleration error drops below a specified threshold. One advantage of this approach is that the traction assist ends when the vehicle acceleration error goal is achieved while the controller may be implemented as if the vehicle velocity is being tracked because the vehicle velocity can be more directly correlated to the wheel speeds.

The control of a vehicle is complex because the velocity of the vehicle vₓ and yaw rate of the vehicle, r, may be controlled by the interaction of the tires on the road surface. Due to the variant road surface conditions, as well as changing tire ground interaction, the interaction between the tires and road surface is a complex dynamics unknown at any given time. In calculating the desired vehicle wheel speed for each wheel that is to be adjusted, the nominal desired wheel speed must be calculated as well as the perturbation components of the desired wheel speed. More specifically, the desired wheel speed of each wheel is assumed to be composed as follows:
ω_{d,RL}=\overline{ω}_{d,RL}+\tilde{ω}_{d,RL} (6)
ω_{d,RR}=\overline{ω}_{d,RR}+\tilde{ω}_{d,RR} (7)
where \overline{ω} is the nominal term and \tilde{ω} is the correction or perturbation term for the desired velocity for each wheel and ω_{d,RL} stands for the desired wheel speed of the rear left wheel and ω_{d,RR} stands for the desired wheel speed of the rear right wheel. It should be readily recognizable to one skilled in the art that the following equations may also be applied to the front wheels of a vehicle and that the rear wheels are only used as a non-limiting example. The nominal wheel speeds are derived from kinematic relation between a vehicle and wheel behavior as if no wheel slip existed and are given as follows:

$$\begin{matrix}{ϖ}_{d , RL} = \frac{{v}_{x} - br}{{R}_{RL}} & ( 8 ) \\ {ϖ}_{d , RR} = \frac{{v}_{x} + br}{{R}_{RR}} & ( 9 )\end{matrix}$$

where vₓ is the current velocity of the vehicle, r_{d} is the desired yaw rate, and b is half the width between the corresponding left and right wheels. Next the perturbation velocity components must be calculated. The perturbation velocity components may be calculated as follows:

$$\begin{matrix}{\dot{\tilde{ω}}}_{d , RL} + {k}_{RL} {\tilde{ω}}_{d , RL} = {k}_{RL} \cdot g ( {\hat{μ}}_{L}^{′} ) \cdot h ( \frac{{e}_{v} - {be}_{r}}{{R}_{RL}} ) & ( 10 ) \\ {\dot{\tilde{ω}}}_{d , RR} + {k}_{RR} {\tilde{ω}}_{d , RR} = {k}_{RR} \cdot g ( {\hat{μ}}_{R}^{′} ) \cdot h ( \frac{{e}_{v} - {be}_{r}}{{R}_{RR}} ) & ( 11 )\end{matrix}$$

where k_{RL}, k_{RR} are constant gains, \hat{μ}′_{L}, \hat{μ}′_{R} are the estimates of the friction coefficient gradients (Step 150) with respect to longitudinal slip ratios for the left and right tires respectively, g(\hat{μ}′_{R}) and g(\hat{μ}′_{L}) are the hysteresis characteristics for sign of \hat{μ}′_{L}, \hat{μ}′_{R} respectively as shown in FIG. 5, and h(x), more specifically

$$h ( \frac{{e}_{v} - {be}_{r}}{{R}_{RL}} )$$

for the left rear wheel as well as

$$h ( \frac{{e}_{v} - {be}_{r}}{{R}_{RR}} )$$

for the right rear wheel, are the dead-band characteristics shown in FIG. 6.

More specifically, g(\hat{μ}′_{R}) may be defined as (Step 142):

$$g ( {\hat{μ}}_{R}^{′} ) = \{ \begin{matrix}1 & {μ}^{′} > {δ}_{2} \\ - 1 & {μ}^{′} < {δ}_{1} \\ 1 & {δ}_{1} < {μ}^{′} < {δ}_{2} , and {μ}^{′} is decreasing \\ - 1 & {δ}_{1} < {μ}^{′} < {δ}_{2} , and {μ}^{′} is decreasing\end{matrix}$$

and h(x) may be defined as (Step 144):

$$h ( x ) = \{ \begin{matrix}0 & \vert h ( x ) \vert < δ \\ x & otherwise\end{matrix}$$

The desired wheel speed for each wheel may be calculated by the processor by inputting the results of equations (8)-(11) into equations (6) and (7). The derivative of the desired wheel angular velocity may be obtained by differentiating and then passing the result through a suitable low pass filter to smooth out the results. The hysteresis feature, g(\hat{μ}′_{R}), described above helps eliminate chattering when operating near the peak of friction-slip characteristic by delaying the switch from positive sign to negative sign for gradient of friction-slip characteristic, as shown in FIG. 5. The dead-band feature described above and in FIG. 6 keeps the controller from reacting to very small errors in vehicle velocity and yaw rate and also keeps controller relatively immune to noise in the signals that may result in false report of a small error. While suitable relationships for determining the desired wheel speed and perturbation components are discussed above, those skilled in the art will understand other methods and equations may be used.

Virtually any conventional method of calculating the friction coefficient between the road surface and respective wheel may be used. The accuracy of the friction calculation is not essential, because the present invention generally considers the sign of the friction coefficient gradient to determine if there is wheel slip or if wheel slip will occur when the additional torque is applied.

In the illustrated embodiment, the processor 30 calculates the friction coefficient generally using the sensor signals indicative of the vehicle travel state. As described below in greater detail, the processor 30 determines a desired vehicle velocity, a desired vehicle wheel speed, a desired wheel speed based longitudinal slip ratio (also referred as desired wheel slip ratio in this document), and a friction coefficient. More specifically, the processor 30 uses a Fourier series to calculate the friction coefficient of a driven wheel based on the desired wheel slip ratio. The use of a Fourier series allows improved accuracy because the Fourier series coefficients may be adjusted each cycle to adapt to any changes.

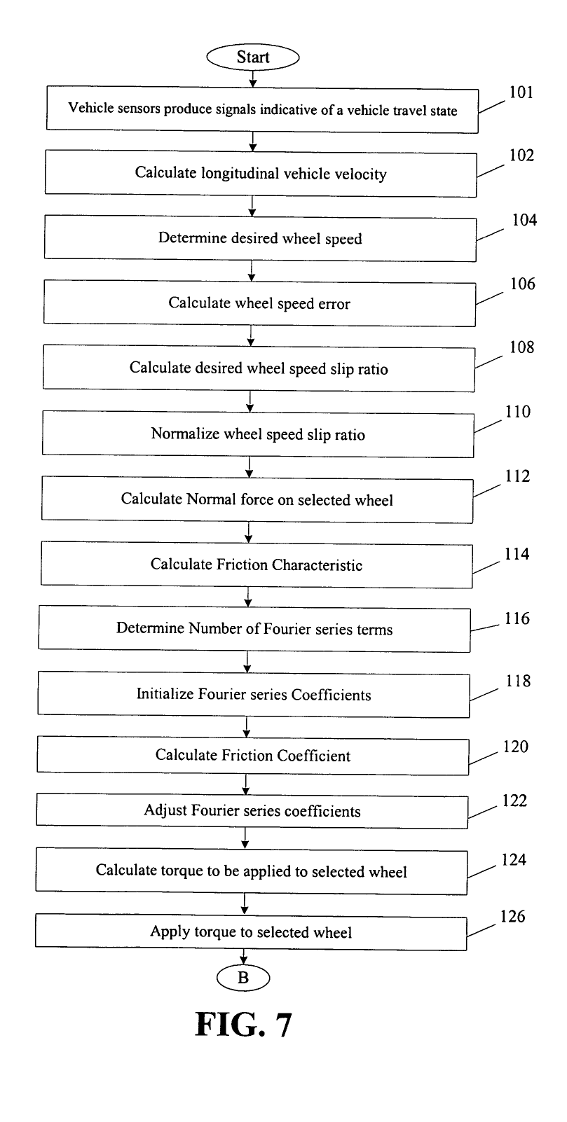

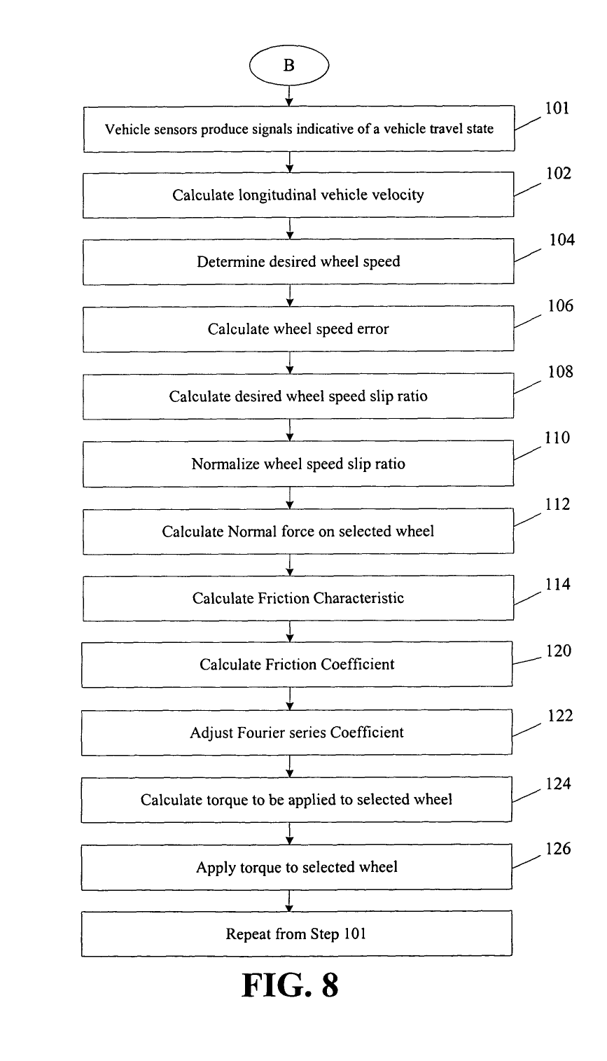

As noted above, in calculating the friction coefficient, FIG. 7 shows the preferred steps performed by the processor 30, beginning with receipt of vehicle sensor signals indicative of a vehicle travel state (Step 101) through the application of torque to the selected wheel (Step 126). FIG. 8 illustrates representative processor steps performed during the repeated or cycled portion of the system and method, generally including the same steps as shown in FIG. 7, except for calculating the number of Fourier series terms (Step 116) and initializing the series coefficients (Step 118). As illustrated, the initial cycle of the yaw rate or acceleration (FIG. 1) corresponds with the initial cycle of the friction coefficient (FIG. 7), while the repeated cycle corresponds to FIGS. 2 and 8. The initial cycle for calculating the friction coefficient includes setting the number of Fourier series terms as well as initialization of the coefficients (Steps 116 and 118).

As stated above, vehicle sensors 31 provide data signals indicative of the motion of the vehicle (i.e., vehicle or system state) such as vehicle velocity or vehicle acceleration (Step 101, FIGS. 1, 2, 7 and 8). A lateral acceleration may be useful in addition to the longitudinal accelerometer signal used above to calculate the friction coefficient.

In addition to the vehicle parameters listed above, the combined inertia of the wheel motor shaft and connected drive train is known and stored in processor memory.

The processor 30 uses the desired wheel speed calculated above (Step 102) to calculate the wheel speed error (Step 106), which is the difference between the desired vehicle wheel speed and the actual vehicle wheel speed. The wheel speed error (e) may be calculated with the following equation:
e=ω_{d}−ω (14)
where ω_{d} is the desired wheel speed and ω is the measured or actual wheel speed. The desired wheel speed is generally the desired wheel speed calculated in the previous cycle, which may be used even though the desired wheel speed requires the friction coefficient, because during the initial cycle the friction coefficient is initialized (set to zero or a more judicious number if available).

The processor 30 may then calculate a wheel speed slip ratio (Step 108). The wheel speed slip ratio is the relative wheel slip between the surface and the point of contact on the wheel with the surface. More specifically, the wheel longitudinal slip ratio is the slip speed of the wheel contact point with respect to the surface divided by the rim velocity of the wheel, and may be calculated with the following equation:

$$λ = \frac{ω R - {v}_{x}}{ω R} \qquad ( 15 )$$

where (λ) is the wheel slip ratio, (ω) is the actual wheel speed, (R) is the radius of the wheel and (vₓ) is the longitudinal velocity of the vehicle's center of gravity. As discussed above, the radius of the wheel (R) is known and the longitudinal velocity of the vehicle (vₓ) is determined using known estimation techniques as described above.

In the illustrated embodiment, to reduce or eliminate the effect of sensor noise and resulting estimation errors, the processor 30 calculates a desired wheel speed slip ratio (λ_{d}) in place of the actual wheel speed slip ratio (λ) by using the desired wheel speed calculated above. The third module may ensure that the desired wheel speed (ω_{d}) is close enough to the actual wheel speed (ω) so that very little error (e) is introduced by substituting the desired wheel speed for the actual wheel speed. Therefore, Equation (15) becomes:

$${λ}_{d} = \frac{{ω}_{d} R - {v}_{x}}{{ω}_{d} R} \qquad ( 16 )$$

where (λ_{d}) is the desired wheel speed based longitudinal slip ratio, (ω_{d}) is the desired wheel speed, (r) is the radius of the wheel and (vₓ) is the longitudinal velocity of the vehicle's center of gravity.

One advantage of using the desired wheel speed (ω_{d}) in computing the wheel speed slip ratio is that the desired wheel speed is immune to noise found in the wheel speed sensor signal. The processor 30 normalizes the desired wheel slip ratio to constrain the slip ratio between 0 and 2π, to match the input range of the argument to suit harmonic functions (Step 110). The normalized longitudinal wheel slip ratio is defined as:

$${λ}_{d , N} = 2 π ( \frac{{λ}_{d} - {λ}_{d , min}}{{λ}_{d , max} - {λ}_{d , min}} ) \qquad ( 17 )$$

where λ_{d,min} and λ_{d,max} are anticipated minimum and maximum values of λ_{d}. These values may be chosen as 0 for λ_{d,min} which represents no slip and 1 for λ_{d,max} which represents 100% slip.

In Step 112, the processor 30 calculates the normal force (F_{z}) on a selected wheel. The normal force (F_{z}) is conventionally known as the force exerted by a surface on the wheel normal to surface and may also be referred to as the total load, (i.e., the sum of dynamic force and static load), on a wheel. When a vehicle is at rest, the normal force (F_{z}) for each wheel is generally the static load, determined by vehicle weight and location of its center of gravity with respect to wheel locations. As the vehicle is driven within various parameters and conditions, such as acceleration or turning, the normal force (F_{z}) on each wheel may vary due to dynamic load transfer. Dynamic load transfer is the load that is transferred from one wheel to the other during various vehicle operations. The dynamic load on each axle may be determined by the following equations:

$$\begin{matrix}{F}_{zf} = W \frac{c}{L} - W \frac{a H}{g L} & ( 18 ) \\ {F}_{zr} = W ( 1 - \frac{c}{L} ) + W \frac{a H}{g L} & ( 19 )\end{matrix}$$

where F_{zf} is the normal force on the front axle 13 and F_{zr} is the normal force on the rear axle 17. The remaining variables represent other vehicle parameters such as vehicle weight (W), distance of vehicle center of gravity from rear axle (c), vehicle acceleration (a), height of center of gravity above the ground (H), acceleration due to gravity (g), and vehicle wheelbase (L). The normal force (F_{z}) on each wheel can be calculated from the normal force on each axle. Equations (20)-(23) may be used to calculate the normal force (F_{z}) of each wheel where F_{zFL} is the normal force on the front left wheel 14, F_{zFR} is the normal force on the front right wheel 12, F_{zRL} is the normal force on the left rear wheel 18, and F_{zRR} is the normal force on the right rear wheel 16.

$$\begin{matrix}{F}_{zFL} = {F}_{zf} \frac{d}{t} + \frac{W}{g} \frac{c}{L} \frac{H}{t} {a}_{y} & ( 20 ) \\ {F}_{zFR} = {F}_{zf} ( 1 - \frac{d}{t} ) - \frac{W}{g} \frac{c}{L} \frac{H}{t} {a}_{y} & ( 21 ) \\ {F}_{zRL} = {F}_{zr} \frac{d}{t} + \frac{W}{g} ( 1 - \frac{c}{L} ) \frac{H}{t} {a}_{y} & ( 22 ) \\ {F}_{zRR} = {F}_{zr} ( 1 - \frac{d}{t} ) - \frac{W}{g} ( 1 - \frac{c}{L} ) \frac{H}{t} {a}_{y} & ( 23 )\end{matrix}$$

Equations (20)-(23) use various known parameters such as the lateral distance between the center of gravity and the wheel on the right side for that particular axle (d), vehicle track width (t), and vehicle lateral acceleration (α_{y})

Equations (20)-(23) take into account the affect of longitudinal and lateral load transfer during acceleration and braking as well as during turning or side slipping. When the vehicle is turned, the normal force on the wheels will be different for the wheels on the inside of the turn as compared to the wheels on the outside of the turn.

The next several paragraphs of this description describe the calculation of the friction coefficient using a Fourier series (Step 120 in FIGS. 7 and 8) including the determination of the number of Fourier series terms and initialization of the coefficients (Steps 116 and 118 in FIG. 7). As noted above, once calculated, the number of terms generally stays constant and the coefficients are adjusted (Step 122) each cycle to improve accuracy and adapt to changing road conditions.

The processor 30 may calculate the friction coefficient using a Fourier series (Step 120). A Fourier series uses a summation of a set number of harmonic terms to converge on the correct value. In the illustrated embodiment, the following Fourier series equation may be used to calculate the friction coefficient:

$${μ}_{d} \approx {a}_{0} + {\sum }_{j = 1}^{n} {a}_{j} Sin ( j {λ}_{d , N} ) \qquad ( 24 )$$

In Equation (24), μ_{d} represents the friction coefficient based on the desired wheel slip ratio, and α₀ and αⱼ's are the coefficients typically associated with Fourier series, j is the index or coefficient number, and λ_{d,N}, is the normalized desired wheel slip ratio defined earlier in Equation (17). The approximate equality sign in the above equation is used to take into account a small modeling error while using a finite number of terms (n) of Fourier series. The modeling error may be determined, if desired, through well known techniques of calculating the error associated with a Fourier series.

One advantage of using a Fourier series in the present invention is that the series is a mathematically complete set of orthogonal functions that can approximate any well behaved function. Unlike conventional techniques for estimating, determining, or calculating the friction characteristic, the use of a Fourier series beneficially provides real time estimation not based on past data. FIG. 7 illustrates an initial method cycle performed before the friction coefficient is calculated. In this initial cycle, the processor 30 determines the number of Fourier series harmonic terms (Step 116). The present invention uses the minimum number of terms necessary for the desired accuracy, typically ten to twenty terms, which when used to calculate yaw rate assist or acceleration assist does not need to be very accurate due to the sign of the friction coefficient gradient being most important (e.g., positive or negative). The number of terms is chosen by the desired accuracy of the estimated friction coefficient or its gradient with respect to desired wheel slip. The number of terms may be based on real world tests that determine the optimal number of terms under specific operating conditions, or may be functionally related to the noise inherent in the sensors.

After the number of terms is determined, the coefficients α₀ and αⱼ's from Equation (24) are initialized (Step 118) in the initial method cycle of FIG. 2. In Equation (24), coefficients α₀ and αⱼ are adjusted or updated with each cycle of the method. When initializing, the coefficients are given values that closely approximate the current vehicle operating conditions to improve accuracy but any value may be used due to the system learning from previous calculations. For example, the processor 30 may refer to a stored look-up table containing initial coefficient values which are preferably determined during testing for a specific set of tires on a specific surface but this exercise is not necessary. It should be readily recognized that because the system learns from previous calculations, the initial coefficients may be chosen arbitrarily, within some bounds. However, a judicious choice is recommended if feasible and available. The closer the initial value is to the correct value, the quicker the system 20 provides an accurate estimation of the friction coefficient. Therefore, the processor 30 may use multiple look-up tables, each associated with specified vehicle states, to allow a more accurate estimation of the friction during the initial method cycle. The selected initial coefficients are generally used each time for the initial cycle which may be only when the car is started, or after the processor is reset. The friction coefficient between a tire and the road is expected to not exceed a certain value for all known combinations of the tire and surfaces. The upper bounds of the friction characteristic, determined during testing, allow a quick and easy check to ensure the friction coefficient is within a specified range.

After the Fourier series coefficients are initialized, the friction coefficient may be calculated as described above in Step 120. After calculation of the friction coefficient, the Fourier series coefficients may be adjusted or updated (Step 122), such as through the use of wheel speed error, which provides a more accurate estimation of the friction coefficient when the cycle is repeated. Other methods of adjusting Fourier series coefficients may also be used to improve estimation of the friction coefficient. The continual adjustment of the coefficients before each cycle allows the error in the friction coefficient to be minimized. To adjust the Fourier series coefficients, the following Euler integration technique may be used:
α_{j,new}=α_{j,old}+\hat{\dot{α}}ⱼ*T_{S} (25)
where T_{S} is the sample time, \hat{\dot{α}}ⱼ is the rate of change for the coefficients, α_{j,old} is the coefficient from the last cycle, and α_{j,new} is the new Fourier series coefficient. The processor 30 may use the following equation to determine the rate of change \hat{\dot{α}}ⱼ for the coefficients:
\hat{\dot{α}}ⱼ=ζⱼRFSin(λ_{d,N})e (26)
where (i) is the number of the harmonic term with which the coefficient is associated, (ζ) is a chosen constant learning rate normally selected to control the change in coefficient value at each computation step, (R) is the radius of the wheel, (Fz) is the normal force on specific wheel, and (e) is the wheel speed error.

In the illustrated embodiment, the sample time for calculating the friction is generally the same as the overall calculation rate of 5 to 20 ms corresponding to a cycle rate of 50 to 200 Hz. However, the sample time and cycle rate may vary. The system 20 may be integrated into current vehicle control systems that generally have a 140 Hz (7 ms) or smaller cycle rate. The estimation methodology for the friction estimation described above is generally tied to the actual wheel speed reaching the desired wheel speed and therefore the performance of the system 20 as a whole. The coefficients may be frozen once the difference between the actual wheel speed and desired (target) wheel speed falls below a specified value, with the specified value being set to any selected difference between the desired and actual wheel speeds depending on the desired accuracy of the friction coefficients. By freezing the coefficients, the calculations are made simpler, thereby allowing more tasks in a given time period, as needed.

Once the Fourier series coefficients are determined, the system calculates a torque to be applied to the wheel, such as in the manner described below (Step 124), and communicates a torque signal to the appropriate torque mechanism 38 for application of the torque to the wheel (Step 126). The processor 30 may include a feedback adaptive wheel speed controller to allow the processor to learn from changes in the dynamics of a system, such as varying road conditions. In the illustrated embodiment, the processor calculates the torque to be applied (Step 124) to the selected wheel as follows:
T=I\dot{ω}_{d}+RF_{z}\hat{μ}_{d}(λ_{d})+K₁e+K₂ρ²e (27)
where: (I) is the combined inertia of the wheel and attached drive train; (K₁) and (K₂) are constant gains of the controller; (ρ) is a controller gain that is higher than the friction coefficient value to ensure proper controller performance; and ω_{d} is the desired wheel speed calculated for a given wheel from Equations (6)-(11). In the illustrated embodiment, a constant value of 1.2 for the controller gain may suffice, although other values may be used. The gains K₁ and K₂ can be chosen to be as high as the torque mechanisms, may support without saturation, and without exciting any other unwanted behavior such as noise and vibration. Before the cycle is repeated in the manner illustrated in FIG. 3, the torque mechanism 38 applies the torque calculated in Equation (27) to the wheel (Step 126) so as to reduce the difference between the actual and desired wheel speeds, as described in greater detail below. The torque mechanism 38 may be of any conventional design including an electric motor attached to a wheel, a braking system, a clutch attached to the wheel to selectively apply a specified torque, or to transfer a torque to a fly wheel. It should be readily recognized that virtually any mechanism that allows a set amount of torque to be applied to the selected wheel may be used.

The present invention quickly, accurately, and efficiently assist in achieving a desired yaw rate, desired acceleration and/or a desired vehicle velocity. The system receives signals indicative of the current vehicle operating state and operator interaction with the vehicle. From these signals a desired vehicle operating state may be determined, and more specifically, the desired wheel speed of one or more of the vehicle wheels, associated with the desired vehicle operating state. From the sensor signals the current wheel speed may be calculated, allowing the system to calculate the wheel speed error. The system uses the wheel speed error in determining a torque to be applied to the wheel so that the current wheel speed approaches the desired wheel speed. A friction coefficient between the wheel and a support surface may also be determined to ensure the torque to be applied will not cause the wheel to slip.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

1. A method of controlling the wheel speed of a vehicle wheel supported by a surface, said method comprising:
receiving a first and second sensor reading indicative of a vehicle state;
determining a current wheel speed from said first sensor reading;
determining a desired wheel speed from said second sensor reading;
determining a wheel speed error based on the difference between said desired wheel speed and said current wheel speed;
determining a torque to be applied to the vehicle wheel from said wheel speed error.

2. The method of claim 1 further including the steps of:
determining a friction coefficient between the wheel and the surface;
determining a current wheel torque using said desired wheel speed, said sensor readings and said friction coefficient;
determining a maximum torque that may be applied without slip of the vehicle wheel;
ensuring that the sum of said torque to be applied and said current torque is less than or approximately equal to said maximum torque.

3. The method of claim 1 further comprising the step of determining a vehicle velocity and wherein the step of determining said current wheel speed is based on said determined vehicle velocity.

4. The method of claim 3 wherein said step of determining a desired wheel speed includes the step of determining a desired vehicle acceleration.

5. The method of claim 3 wherein said step of determining a desired wheel speed further includes the step of determining a desired vehicle velocity.

6. The method of claim 5 wherein said desired vehicle velocity further includes the step of determining a vehicle acceleration.

7. The method of claim 3 wherein said step of determining a desired wheel speed includes the step of determining a desired yaw rate.

8. The method of claim 7 wherein said step of calculating a wheel speed error further includes the step of calculating a yaw rate error.

9. The method of claim 1 wherein said first sensor reading is a vehicle wheel speed and said second sensor reading is indicative of an operator input.

10. The method of claim 1 wherein said torque to be applied (T) is defined by:
T=I\dot{ω}_{d}+RF_{z}\hat{μ}_{d}(λ_{d})+K₁e+K₂ρ²e

11. The method of claim 10 wherein the vehicle includes a left rear wheel and a right rear wheel, and wherein the step of determining a desired wheel speed is based on desired wheel speed for the left rear wheel (ω_{d,RL}) which is defined by:
$$\begin{matrix}{ω}_{d , RL} = \frac{{v}_{x} - b {r}_{d}}{{R}_{RL}} + \\ {\tilde{ω}}_{d , RL} {\vert}_{t = 0} + {ⅇ}^{- {k}_{RL} t} {\int }_{0}^{t} {ⅇ}^{{k}_{RL} t} ( {k}_{RL} \cdot g ( {\hat{μ}}_{L}^{′} ) \cdot h ( \frac{{e}_{v} - b {e}_{r}}{{R}_{RL}} ) ) ⅆ t\end{matrix}$$

12. The method of claim 10 wherein the vehicle includes a left rear wheel and a right rear wheel, and wherein the step of determining a desired wheel speed is based on said desired wheel speed for the right rear wheel (ω_{d,RR}) which is defined by:
$$\begin{matrix}{ω}_{d , RR} = \frac{{v}_{x} - b {r}_{d}}{{R}_{RR}} + {\tilde{ω}}_{d , RR} {\vert}_{t = 0} + \\ {ⅇ}^{- {k}_{RR} t} {\int }_{0}^{t} {ⅇ}^{{k}_{RR} t} ( {k}_{RL} \cdot g ( {\hat{μ}}_{L}^{′} ) \cdot h ( \frac{{e}_{v} - b {e}_{r}}{{R}_{RR}} ) ) ⅆ t\end{matrix}$$

13. A method of controlling the wheel speed of a vehicle wheel supported by a surface, said method comprising:
receiving a sensor reading indicative of a vehicle travel state;
receiving a sensor reading indicative of operator input;
determining a desired yaw rate from said sensor readings indicative of a vehicle travel state and said sensor readings indicative of operator input;
determining a current wheel speed;
determining a desired wheel speed using said desired yaw rate;
calculating a wheel speed error based on the difference between said desired wheel speed and said current wheel speed;
determining an applied torque to be applied to the vehicle wheel from said wheel speed error.

14. The method of claim 13 further comprising the step of calculating a current vehicle velocity from said received sensor readings indicative of a vehicle travel state.

15. The method of claim 13 wherein the vehicle includes a left rear wheel and a right rear wheel, and wherein said step of determining said desired wheel speed includes the step of calculating a nominal desired velocity for each of the left and right wheels of the vehicle.

16. The method of claim 13 wherein said step of determining an applied torque includes the steps of mapping a hysteresis characteristic and mapping a dead band characteristic.

17. The method of claim 13 wherein said sensor reading indicative of operator input is a steering wheel angle signal.

18. A method of controlling the wheel speed of a vehicle wheel supported by a surface, said method comprising:
receiving sensor readings indicative of a vehicle travel state;
receiving sensor readings indicative of operator input;
determining a desired acceleration from said sensor readings indicative of a vehicle travel state and said sensor readings indicative of operator input;
determining a current wheel speed of the vehicle wheel;
determining a desired wheel speed of the vehicle wheel from said desired acceleration;
calculating a wheel speed error, said wheel speed error being the difference between said desired wheel speed and said current wheel speed;
determining an applied torque to be applied to the vehicle wheel from said wheel speed error.

19. The method of claim 18 further comprising the step of calculating a vehicle velocity from said sensor readings indicative of a vehicle travel state.

20. The method of claim 18 wherein said desired acceleration (α_{x,d}) is defined by:
α_{x,d}=Hₜₕ(s)f(xₜₕ,vₓ)−k_{br}x_{br}sgn(vₓ)−kᵥ|vₓ|−k_{α}vₓ²
